(19) United States
(12) Patent Application Publication
(10) Pub. No.: US 2017/0122197 A1
(43) Pub. Date: May 4, 2017

(54) Wotary engine

(71) Applicants: Ray Wolfgang, Pittsburgh, PA (US); Donald J. Crimbchin, Butler, PA (US)

(72) Inventors: Ray Wolfgang, Pittsburgh, PA (US); Donald J. Crimbchin, Butler, PA (US)

(21) Appl. No.: 14/756,946

(22) Filed: Nov. 2, 2015

(51) Int. Cl. F02B 63/04; F02B 55/02; H02K 7/18; F02B 55/08

(52) U.S. Cl. CPC F02B 63/042; F02B 55/08; F02B 55/02; H02K 7/1807

(57) ABSTRACT

The basic Wotary Engine is a mechanical device consisting of two rotating components. A valve rotating within a valve cavity and a piston continuously rotating through a toroidal cylinder. A wide variety of fuels can be used within the toroidal cylinder to convert solid, liquid, or gaseous fuel, as well as energy sources such water pressure, steam, or air pressure, into rotational mechanical output via a shaft and flywheel which are attached to the pistons.

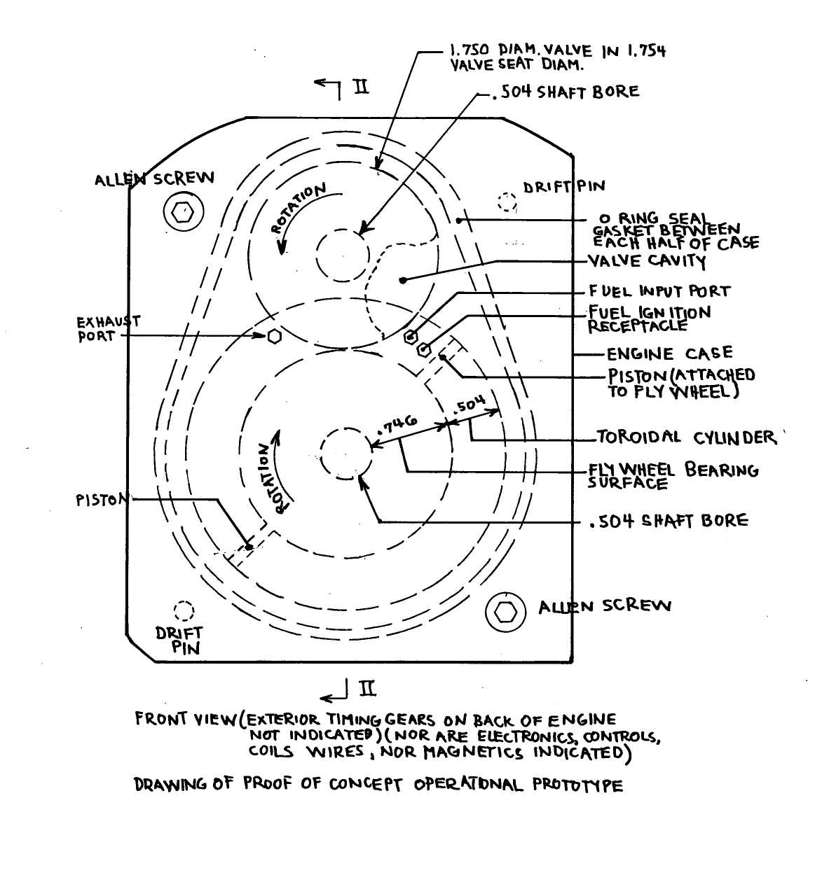

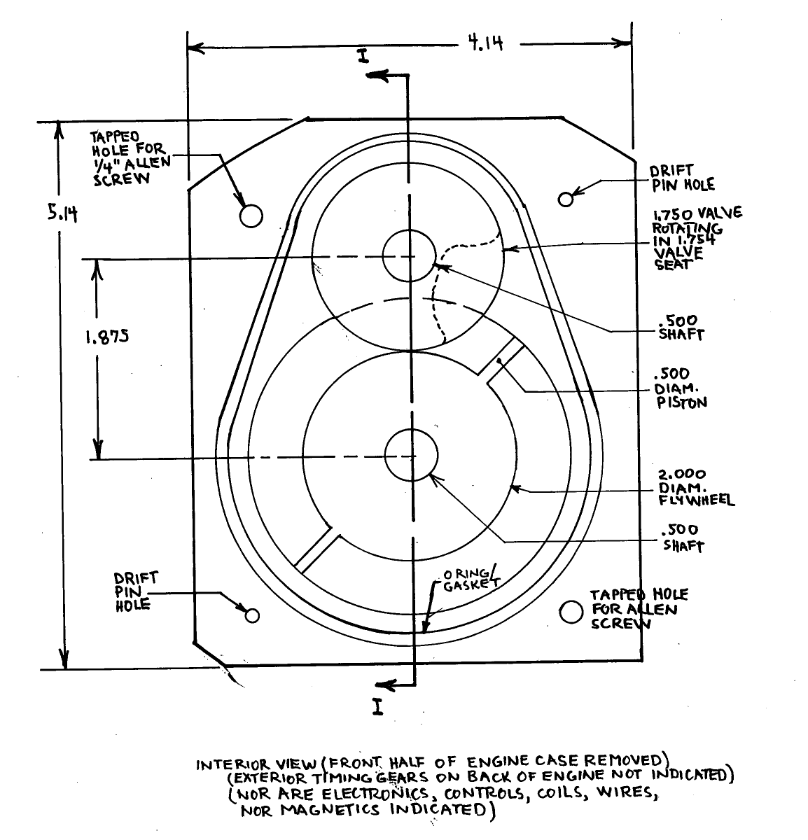

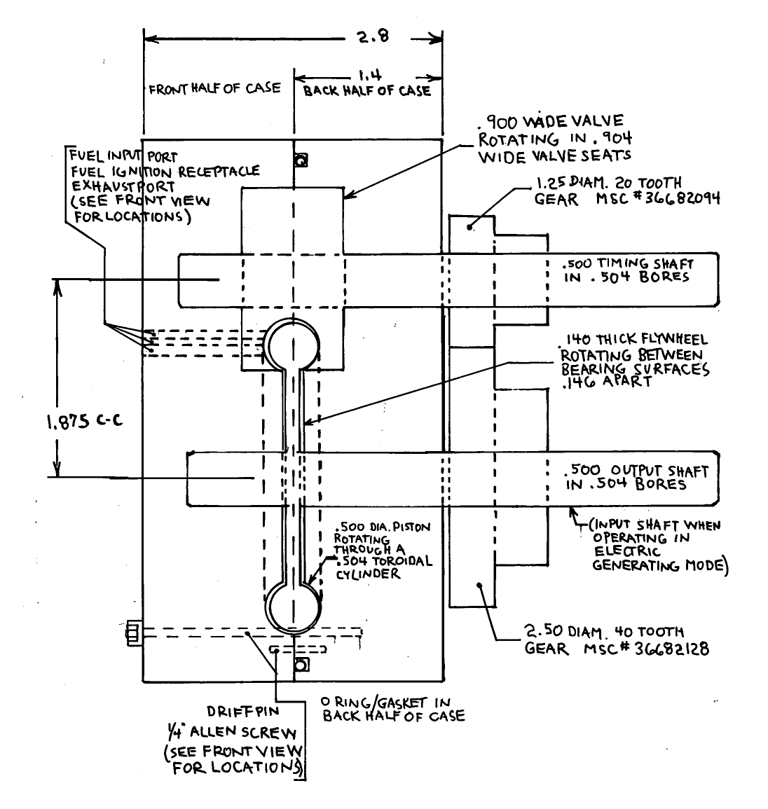

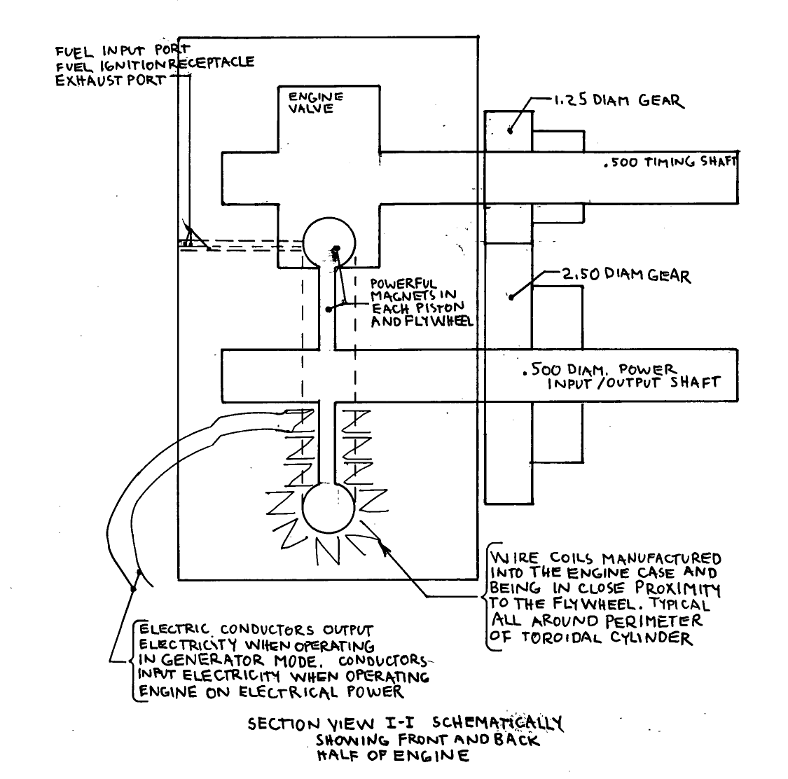

The Wotary Engine can also be constructed with wire coils closely and sequentially surrounding the toroidal cylinder. As a strongly magnetic piston rotates past the coils, electricity can be conducted off the coils.

Properly timed input of electrical energy to the coils can also be used to impart rotary force to the magnetic piston in the Wotary Engine, thus providing yet another energy source for conversion to rotating mechanical output.

The wotary engine consists of a donut, ie., toroidal, shaped continuous cylinder within which pistons rotate. Circular, triangular, square or other shaped cross section shaped cylinders are possible with correspondingly shaped pistons to be used. The pistons are part of a flywheel and shaft which are used to output power from the wotary engine.

Fuel is expanded, within contained portions of the toroidal cylinder, to cause a propelling force directed onto the internal, or windward, side of the piston. The force moves the piston forward in a continuous circular path around the toroid. The contained portion of the toroidal cylinder is that volume between the valve and the windward side of the piston.

The rotating valve is synchronized to the output flywheel and shaft to maintain proper timing of the containment portion of the cylinder and to allow passage of the pistons continuously around the toroidal cylinder The cavity constructed into the rotating valve permits the pistons to pass through the valve.

Expanding gases resulting from combustion of liquid or gaseous, or solid fuels such as gasoline, natural gas, propane, butane, gun powder, etc within the contained volume of the cylinder can be used to provide energy to power the wotary engine. Externally produced fuel such as compressed air, steam or even water under pressure, supplied into the contained volume of the toroidal cylinder can be used to impart force against the internal windward side of the piston thus propelling the piston forward around the toroidal cylinder. This force on the piston rotates the connected flywheel and shaft enabling controlled work to be output from the power, (input/output), shaft.

Expanded fuel volumes are exhausted out an exhaust port located in the non-contained portion of the toroidal cylinder.

The next piston rotates into position at the beginning of the contained region of the cylinder resulting in repetition of this process. Multiple numbers of pistons located at various positions upon the outside edge of the flywheel may be used. The particular working prototype model diagrammed in this application has two pistons situated 180 degrees apart.

A bank of two or more toroidal cylinders can be connected via the timing and output shafts being synchronized to provide ongoing and increased rotational force. The pistons of any additional cylinders are offset several degrees from those of the first cylinder. A single cylinder wotary engine results in a brief period during which the contained volume dissipates as a piston rotates through the interstice of the valve and the point where a contained cylinder volume can again be fueled. Momentum of the piston, flywheel, shaft, and valve typically carries the piston forward through the valve interstice into the region where fuel is again accepted into the contained volume to provide ongoing force against the internal side of the piston. Adding one or more synchronized offset cylinder banks disregards the concerns of required momentum as the additional cylinder bank will provide positive force from alternate cylinders.

Combustible fuels enter the contained volume of the cylinder through a controlled metering port. The fuel is ignited at the proper time via externally generated electrical sparks or heating elements located at the perimeter of the contained volume. Externally produced fuel sources such as compressed air, steam, or water pressure are similarly provided through metering ports, but lack the necessity of ignition.

The wotary engine may be customized during manufacturing to accommodate anticipated specific or variable operating conditions and availability of fuels, using a wide variety of cast, and, or machined materials methods.

The particularly dimensioned plans and drawings, for the operating prototype demonstration model, included in the application are easily scaled up to larger and more powerful functioning units with different configurations of valve timing, fuel metering, and synchronization of other aspects of the wotary engine.

Coils of wire constructed into the wotary engine case and being in close proximity to magnetic materials of which are constructed within the pistons and flywheel.create electrical current flowing within the coils of wire as those powerful magnets in the pistons and flywheel pass by the coils. Electrical current can be conducted off for use.

The wotary engine can be fueled by electrical power when it is constructed with appropriate coils of wire and powerful magnets. Use of electricity as a fuel source to power the wotary engine as in a conventional electric motor provides for switching back and forth from electricity to other fuels, such as gasoline, within the same engine unit.

An example of an ideal operational application would be a hybrid automobile. Energy efficiencies can be achieved by lighter weight of a single unit capable of simultaneously using various proportions of electrical power from batteries combined with gasoline. Braking energy used for slowing or stopping the vehicle can be recovered by linking braking devices to the power shaft of the wotary engine to spin the flywheel and pistons thus producing electricity to charge batteries.

1. The continuous toroidal cylinder arranged with a synchronized rotating valve is unique with respect to the valve cavity allowing the pistons to continuously rotate around the interior of the cylinder. The construction of the pistons, attached to the perimeter of the flywheel, result in continuous rotational power output without reciprocating motion of components. Hence the continuous rotation provides for the mechanism's flexibility to produce electrical output as well as to use electricity to power the wotary engine when the engine is constructed with the appropriate wire coils and magnetics.

2. Energy efficiencies are gained because the wotary engine has no reciprocating components to result in loss of momentum.

3. Manufacturing efficiencies result because there is only two moving parts in the basic wotary engine.

4. Operating efficiencies occur because fewer parts result in less weight for this engine.

5. Portability of quickly and easily coupling power shafts of individual wotary engines together in banks allows modifications to accommodate power load demands of a particular use then returned back to a lesser tare weight for lighter duty applications.

6. More direct production of electrical power by encircling the toroidal cylinder with coils of wire while using powerfully magnetized pistons and flywheel: Hence a single mechanism can quickly switch between, (and simultaneously use), electrical power and other fuel sources. (Separate electrical power output/input modes are possible)

7. Flexibility of varied fuel types is possible for convenience as well as emergency situation where a specific fuel may not be available. The wotary engine may be powered by electricity when provided with wire coil windings and magnetics making the wotary very suitable for hybrid engine applications. (Electrical power input mode)

8. Recovery of braking, downhill and coasting forces directed to the wotary engine power shaft can be used to produce electrical power output for storage. (Electrical power output mode).

9. The structural arrangement and continuous rotational operation of the rotating valve in conjunction with the continuous rotation of the wotary engine pistons within the toroidal cylinders provides for comingling of combustible fuels, (or externally produced fuels such as air pressure, steam, water pressure), and electrical power usage, (and, or, generation of electrical power), within a single integral unit.
